(19) United States
(12) Patent Application Publication
(10) Pub. No.: US 2015/0191189 A1
(43) Pub. Date: Jul. 9, 2015

(54) MOVING CONTAINER SYSTEM AND METHOD

(71) Applicant: Aldo Disorbo, Margate, FL (US)

(72) Inventor: Aldo Disorbo, Margate, FL (US)

(21) Appl. No.: 14/493,179

(22) Filed: Sep. 22, 2014

Related U.S. Application Data
(60) Provisional application No. 61/880,960, filed on Sep. 22, 2013.

(51) Int. Cl. B62B 3/00; B62B 5/04; B62B 5/06; B62B 3/02

(52) U.S. Cl. CPC B62B 3/004; B62B 3/005; B62B 3/02; B62B 5/0457; B62B 5/067

(57) ABSTRACT

One or more containers having wheels on the bottom and a secure, but removable door may be used to pack items at a location. The containers may include one or more shelves and may have a rod for hanging clothes. The containers may also have handles that allow an operator to easily manipulate the container and loaded and unloaded from a truck or other vehicle. The containers may be padded on the inside and/or outside. The door may be secured to the container by means of clamps that are relatively difficult to remove in order to prevent accidental removal or theft of an object.

### CROSS-REFERENCE TO RELATED APPLICATIONS

This application claims priority to U.S. Provisional Application Ser. No. 61/880,960 filed on Sep. 22, 2013, the contents of which are hereby incorporated in their entirety.

### STATEMENT REGARDING FEDERALLY SPONSORED RESEARCH OR DEVELOPMENT

Not Applicable.

### NAMES OF PARTIES TO A JOINT RESEARCH AGREEMENT

Not Applicable

### REFERENCE TO SEQUENCE LISTING, A TABLE, OR A COMPUTER PROGRAM LISTING APPENDIX SUBMITTED ON A COMPACT DISC AND INCORPORATION-BY-REFERENCE OF THE MATERIAL

Not Applicable.

### COPYRIGHT NOTICE

Not Applicable

### BACKGROUND OF THE INVENTION

1. Field of Endeavor

The present invention relates to systems and methods for transporting a variety of objects. More particularly, the invention relates to packing and transporting objects in a quick and efficient manner.

2. Background Information

Moving a home or office is not generally considered a pleasant experience. Usually it involves packing all material objects and possessions into boxes or crates, transporting those boxes and crates to the new location and then unpacking the boxes and crates.

The initial packing is often complicated by the simple fact that many objects are not well suited to packing into square boxes. Clothing and other material may be wrinkled and delicate objects may be broken. It may also be difficult to find boxes or crates of an appropriate size.

Once objects have been adequately packed, the boxes or crates must be placed in some sort of transportation vehicle such as for example a truck, a train, a car, a boat, an airplane or the like. Placing the boxes and crates into the transportation vehicle may be difficult. The boxes must be arranged to make efficient use of space and must also be held in place to avoid movement and jostling during the transportation. Persons loading a moving truck may feel as though they are playing a real-life game of Tetris®. Unloading a truck or other vehicle and unpacking boxes is generally less troublesome than the initial loading and transporting.

It is common to hire a moving company to assist in transportation or relocation. While this adds manpower and utilizes skilled workers, it remains a difficult and cumbersome process. This does not eliminate the difficulty of adequately and properly loading boxes and crates into a transportation vehicle.

Skilled workers as well as people moving by themselves often utilize dollies, carts, or other hand driven devices with wheels designed to carry other objects. While use of these carts makes the process easier, they come with their own problems as well. Generally several boxes or crates are stacked one on top of the other on a dolly or cart. Any time the device hits a bump or uneven surface on the ground boxes may potentially slide off. This makes using such carts a slow and time intensive process. There have been efforts in the prior art to design boxes or containers specifically suited to particular dollies or hand carts. However these require purchasing and exclusive use of containers and carts they are still not adequately steady.

The transportation process is notoriously hard on both the objects being moved and the locations they are being removed from and placed into. Furniture and other objects may be scuffed, scraped or broken. It is also common for hallways and especially doorways to get nicked, scratched or marked up by accidental bumping with boxes and furniture. Large apartment and condominium buildings dread the moving process because it inevitably means damage throughout the common areas. To ameliorate these problems movers often utilize thick blankets, foam or other padding to place over or wrap around furniture, large crates and boxes or other objects. However, such blankets and padding easily slide off and often do not adequately cover all sharp corners and hard spots.

In addition, moving often results in the one time use of and often waste of many boxes as well as packaging material. This both increases expenses and is harmful to the environment. Purchasing boxes can be costly. When a move is done, many persons have no desire to store a large number of boxes, which must therefore be discarded.

In view of the foregoing, there is a need for an improved system and method for transporting and/or relocating items from one location to another. It is therefore desirable to provide a system and method for transporting and relocating a plurality of objects in a manner that efficiently relocates them without damaging the objects or their surroundings. It is also desirable to provide systems and methods for moving that are more environmentally friendly and better organized.

### BRIEF SUMMARY OF THE INVENTION

Accordingly, the primary object of the present invention is to provide an efficient and effective means for transporting and relocating possessions that reduces the damage caused and allows for rapid loading of a transportation vehicle.

The present invention provides a system and method for moving a large number of objects from an office or home into a new location in a manner that is organized, simplified, minimizes waste, is secure, and minimizes damage to homes, offices and the like. Generally, the invention provides a plurality of containers. The containers have a parallelepiped shape and are thus easily packed together when loaded onto a transportation vehicle such as a truck, van, boat, airplane or the like and are sized to fit through doorways and on elevators. Optionally, they also provide for efficient long-term storage.

The moving containers are generally large oblong boxes having wheels at the bottom. One side of the container, generally referred to herein as a door, may be removed so that objects may be packed into the container for transport. Once the container is loaded and packed, the door may be replaced and secured to the container. Because the container has wheels and handles, one person, generally, may manipulate the container as it is transported from a location to a loading vehicle and later from a loading vehicle to a second location. This simplifies the moving process. Persons packing up objects are no longer required to pack several boxes which must be placed on a dolly and then transported and loaded into a vehicle. Instead, the containers of the invention may be packed at the location and loaded onto the transportation vehicle. No dollies are required. The number of boxes used is also greatly reduced because the container may include several shelves on which items may be packed directly. Boxes may still be used if desired, but are less necessary.

These and other objects and advantages of the present invention will become apparent from a reading of the attached specification and appended claims. There has thus been outlined, rather broadly, the more important features of the invention in order that the detailed description thereof that follows may be better understood, and in order that the present contribution to the art may be better appreciated. There are features of the invention that will be described hereinafter and which will form the subject matter of the claims appended hereto.

### BRIEF DESCRIPTION OF THE DRAWINGS

A more complete understanding of the present invention, and the attendant advantages and features thereof, will be more readily understood by reference to the following detailed description when considered in conjunction with the accompanying drawings wherein:

FIG. 1 is a front perspective view of a moving container in accordance with the principles of the invention;

FIG. 1a is a bottom view of a moving container in accordance with the principles of the invention;

FIG. 2 is a a front view of door for a moving container in accordance with the principles of the invention;

FIG. 3 is several views of a clamp for use with a moving container in accordance with the principles of the invention;

FIG. 4 is a perspective front view of a container in accordance with the principles of the invention;

FIG. 5 is a perspective front view of a container in accordance with principles of the invention;

FIG. 6 is a perspective front view of a container containing hanging clothes and other objects including boxes in accordance with the principles of the invention;

FIG. 7 is a perspective view of a container without a door in accordance with principles of the invention;

FIG. 8 is a perspective view of a container with a door secured to it by clamps in accordance with the principles of the invention;

FIG. 9 is an enlarged view of a clamp securing a door to a container in accordance with the principles of the invention;

FIG. 10 is a perspective environmental view of an alternative embodiment of a container in accordance with the principles of the invention;

FIG. 11 is an environmental view of an alternative embodiment of a container in accordance principles of the invention;

FIG. 12 is a front view of an alternative embodiment of a handle for use with a container in accordance with the principles of the invention;

FIG. 13 is a front perspective view of a container in accordance with the principles of the invention;

FIG. 14 is a front view of a back panel of a container in accordance with the principles of the invention;

FIG. 15 is a door for a container in accordance with principles of the invention;

FIG. 16 is a front perspective view of an alternative embodiment of a container in accordance with principles of the invention;

FIG. 17 is an exterior of a side panel of a container in accordance with the principles of the invention;

FIG. 18 is an interior of a side panel of a container in accordance with the principles of the invention;

FIG. 19 is an alternative embodiment of an interior of a side panel of a container in accordance with principles of the invention;

FIG. 20 is a plan view of a bottom panel of a container in accordance with the principles of the invention;

FIG. 22 is a front plan view of an alternative embodiment of a container in accordance with the principles of the invention;

FIG. 23 is a perspective view of an alternative embodiment of a container in accordance with the principles of the invention;

FIG. 23A is an enlarged view of a clamp of the alternative embodiment of a container in accordance with the principles of the invention shown in FIG. 23;

FIG. 23B is an enlarged view of the padding of the alternative embodiment of a container in accordance with the principles of the invention shown in FIG. 23.

### DETAILED DESCRIPTION

Before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

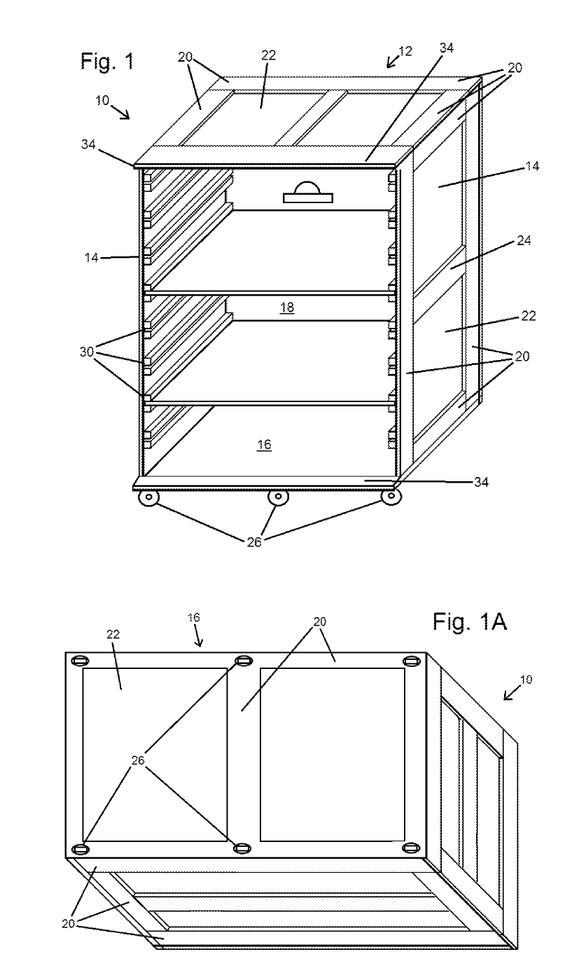

FIG. 1 shows a container in accordance with the principles of the invention. Container 10 is substantially parallelepiped shape and may be defined by a top panel 12, two side panels 14, a bottom panel 16 and a back panel 18. The top panel 12, side panels 14 and bottom panel 16 define a front opening that may provide access to the interior of the container 10 and may be closed by attaching a door over opening 11.

Each of the top panel 12, side panels 14, the bottom panel 16 and the back panel 18 may be comprised of a frame made up of a plurality of beams 20 and planar boards 22. The beams may be 1″×6″, ½″×6″, 2″×4″ or other dimensions, and may be made of wood. Optionally, the beams 20 may be made of other materials, for example HDPE, carbon fiber, metal, metal alloy or the like, so long as it is substantially rigid, capable of serving as a frame for the container, and has sufficient strength to hold the objects placed in it and to be safely transported.

The planar boards 22 may be supported by the framing beams 20 and therefore may be comprised of less sturdy material. Particleboard, plywood, thin plastic, or even a cloth material may be adequate for at least portions of the boards 22. It may be preferable for boards 22 to be nontransparent.

A plurality of slots 30 may be arranged vertically on the interior of side panels 14 and may optionally also be located on the interior of the back panel 18. One or more shelves 28 may be removably engaged with slots 30 to provide shelves within the container. Objects may be placed on the shelves 28. The shelves 28 may be spaced to best accommodate the objects placed in the container 10. The shelves 28 may be used to support boxes that have been packed. Optionally, items usually packed within a box may be stored directly on the shelves 28. Optionally, a rod or bar may be removably fixed near the top of the inside of the container 10 so that hanging clothes may be placed thereon. Optionally, instead of slots, a single protruding shoulder may be used to support shelves. Similarly, other mechanisms may be used to facilitate removable secure engagement of the shelves within the containers.

Handles 24 may be positioned on the exterior of the sides 14. The handles shown here are comprised of “O” or “D” rings. The handles may be comprised of any suitable mechanical device operable as a handle for firmly grasping. It may be preferable to include handles such as those shown in FIG. 1, which lie flat against the side or which may be positioned completely flush with or in the side 14 so that containers 10 may be compactly grouped together.

A plurality of wheels 26 may be located on the bottom of the container bottom panel 16. In this embodiment, six wheels 26 are located on the bottom of the container. It may be desirable to use more or fewer wheels. The wheels may be capable of swiveling about. In some embodiments, only the wheels located on the corners of the container swivel while the middle wheels do not swivel. It may also be desirable to include one or more wheels 26 in the center of the bottom panel 16 as opposed to the perimeter of the bottom panel 16.

Top panel 12 and bottom panel 16 may also include lips 34. Lips 34 may assist in securing a door over the front of the container 10 in order to seal it during transportation. Optionally, a logo, trademark, or ornamental feature 32 may be included at one or more locations on the container 10.

FIG. 1a shows the container 10 from the bottom. In this figure, it can be seen that bottom 16 and back 18 may also be formed from beams 20 which may create a frame to support panels 22. Container 10 may optionally be comprised of wood or other materials which may be readily availability. Optionally, the container may be comprised of any suitable materials such as plastics, metals, carbon fiber, or other materials.

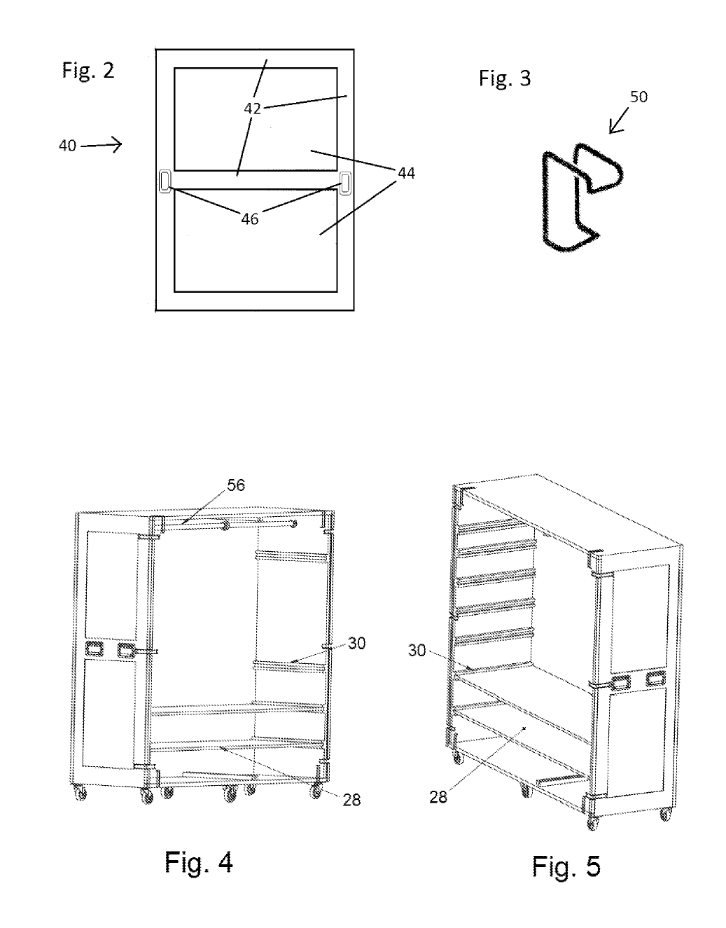

FIG. 2 shows a door 40, which may optionally be referred to as a front panel, for use with the container 10 of FIGS. 1 and 1a. The door 40 may be comprised of a frame made of beams 42 and planks 44. The door may optionally include handles 46. The door 40 may be secured in place over the front by lips 34 and further secured using clamp 50 that may be attached and removed by hand without using a tool.

FIG. 3 shows a clamp 50 commonly used for holding together various storage containers for furniture and the like. A clamp 50 may be used to secure the door to the container 10. As will be explained in more detail below.

FIGS. 4 and 5 provide a perspective view of the interiors container 10. In these figures, shelves 28 are shown engaged with slots 30 in order to provide shelves for supporting objects within the container 10. In FIG. 4 rod 56 may be seen incorporated into the interior of the container 10. Rod 56 may be used to support hanging clothes during transport.

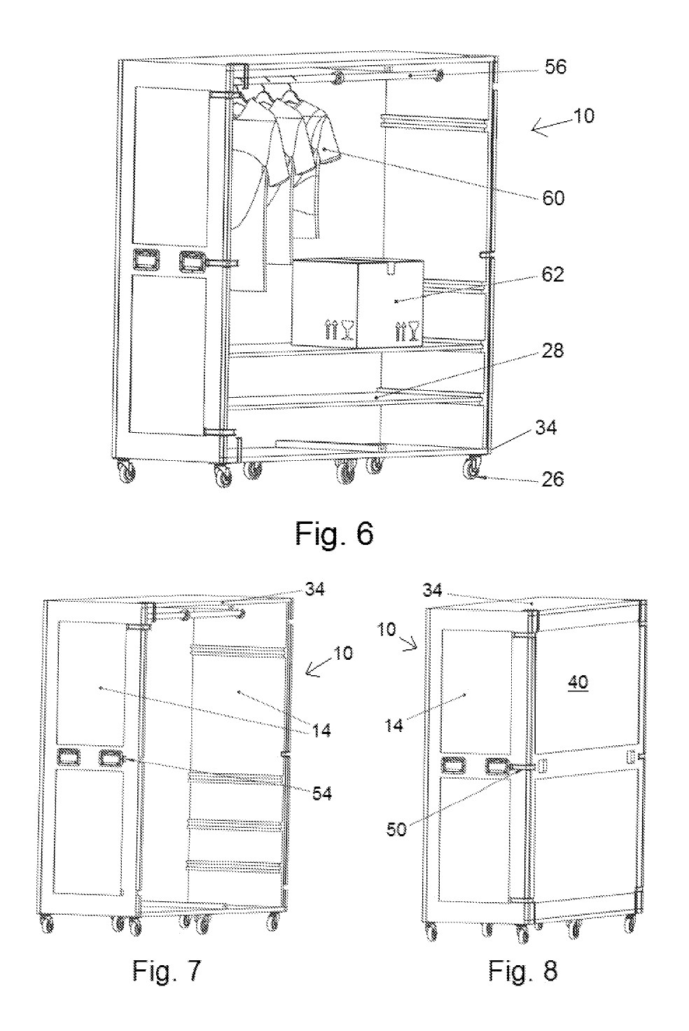

FIG. 6 shows a container 10 having items stored with in it. Hanging clothes 60 may be supported by rod 56. While boxes 62 are supported by shelf 28 and the bottom 16. Wheels 26 protrude from the bottom 16. Lips 34 may also be seen, which may assist in aligning and securing a door to the container 10. In order to provide secure packing, loading and transportation.

FIG. 7 shows a container 10 without a door 40 attached, while FIG. 8 shows the same container 10 having a door 40 removably affixed. Door 46 may be positioned between the lips 34 and may be secured to the sides 14 by means of the clamp 50. In this embodiment, sides 14 include one or more slots 54 into which clamps 50 may be engaged to secure door 42 to the container 10. Those skilled in the art will appreciate that the use of clamps 50 with slots 54 is a known method for securing storage containers. Some storage containers used primarily for storing and not intended to be moved or jostled, may be held together entirely by such clamps. Containers 10, however, are preferably built using screws, glue, nuts and bolts, adhesives, dowels and/or combinations of the above. Only the door 40 is a fixed to the container by means of clamps 50. The strength resulting from these more secure means of connecting the various components of the containers may make the containers sufficiently sturdy to withstand the jostling and exterior forces imposed upon them during transportation.

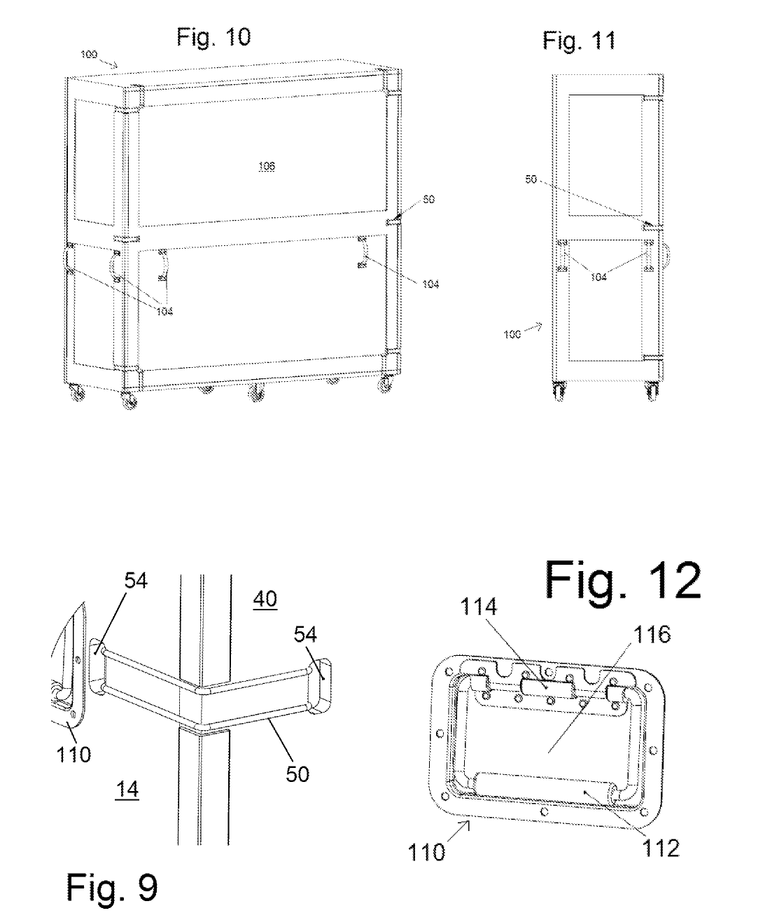

FIG. 9 is an enlarged, close-up view of the clamp 50 and slots 54 used to secure the door 42 the container 10. Those skilled in the art will appreciate that removing clamps 50 from slots 54 takes more effort than that required to slip, a latch or turn a doorknob. Removal of a clamp 50 is preferably accomplished using a screwdriver, crowbar or similar device. Using a clamp 50 that requires substantial effort to remove provides for very secure attachment of the door 42 to the container 10. In addition, use of a clamp 50 to discourage is persons in the vicinity from attempting to remove the door and view the contents of the container 10. Often during a move it is desirable to leave various items, such as containers and boxes, unattended for short periods. For example, it may be desirable to leave a container while a mover ensures that doors or unlocked or that an elevator is available. Unattended moving containers may provide a temptation to less honest people. It is generally known that during a move containers often contain valuable items. While the use of a clamp 50 with slots 54 does not prevent the opening of the container, it may provide sufficient difficulty to dissuade any potential thieves. Further, unlike a lock that requires a key, the clamps are still relatively easy to remove by the proper owner. Thus, the container's 10 provide additional security that is found with typical boxes, but did not add additional difficulty to the movers themselves.

FIGS. 10 and 11 show an alternative embodiment of a container 100 during use in transporting objects from one location to another. As may be seen in FIG. 10, the container 100 may be moved, directed and handled by a single operator with relative ease. In addition, as seen in FIG. 11, the container 100 easily fits within hallways of an apartment or condominium building. It may be navigated around corners, elevators and doorways with relative ease and is still small enough to reduce the likelihood of damage.

Container 100 includes handles 104 that are simple U-shaped handles. These handles 104 are relatively inexpensive and easily incorporated into the container 100. However, handles 104 also may be susceptible to being smashed when several containers 100 are packed together inside a truck or other moving vehicle. It may therefore be more desirable to use handles that fold flat or otherwise do not protrude.

Container 100 also utilizes clamps 52, hold the door 106 firmly secured to the container 100. In this embodiment, a clamp 50 is also used to secure the door 106 to the top of the container 100 in addition to the sides.

FIG. 12 shows an alternative embodiment of a handle 110 for use with a moving container in accordance with the principles of the invention handle 110 may include a recess 116 in which handle 112 may reside when not in use. When an operator grasps the handle 112. It may rotate outward by pivoting at hinge 114. When a handle 112 is no longer being used, gravity may pull it into recess 116. When the handle 112 resides within recess 116 it may not protrude from the door or side into which it is incorporated. This may allow moving containers in accordance with principles of the invention to be placed completely flush with and abutting other containers when loaded into a truck or other vehicle. This may also prevent damaging a handle when containers are placed adjacent to each other.

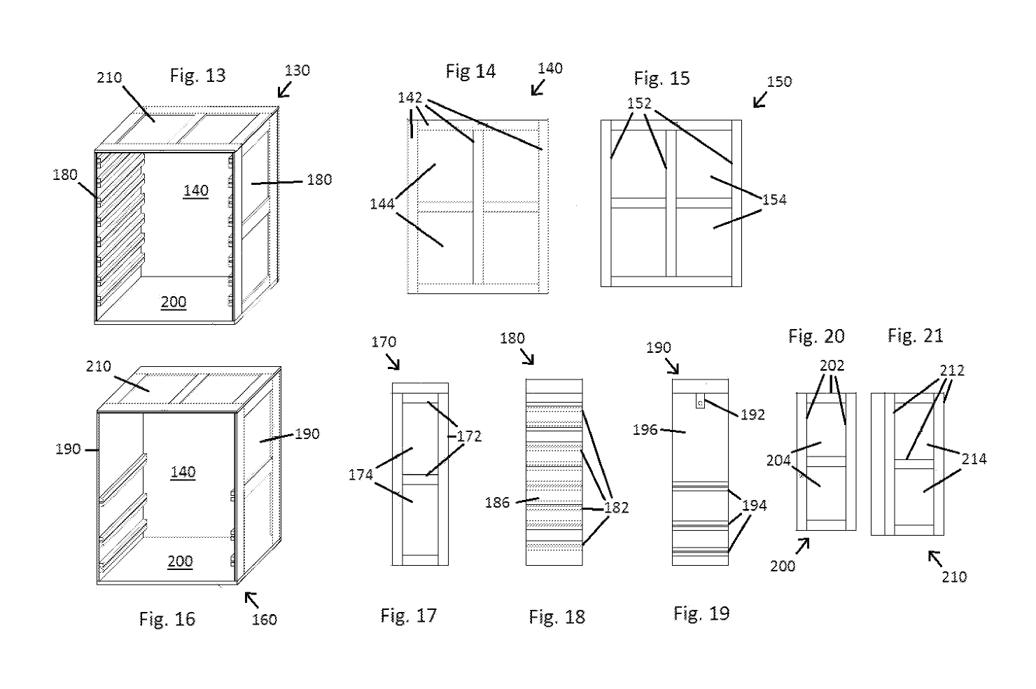

FIG. 13 shows an alternative embodiment of a container 130 in accordance with the principles of the invention. The container 130 may be comprised of a top panel 210, a bottom panel 200, a back panel 140 and two side panels 180. As may be seen, the side panels 180 may include a plurality of slots 182 along their interiors that may be used to removably engage one or more shelves inside the container 130. A container 130 may be preferable for use in moving items that do not include hanging clothes.

FIG. 14 shows a back panel 140 that may be used with any of the containers in accordance with the principles of the invention as described herein. Back panel 140 may be comprised of several beams 142 that may form a frame for the back panel 140. Beams 142 may give structural strength and support to back panel 140. Planks 144 may be comprised of one or more broad planks of plywood or other similar material.

FIG. 15 shows a door panel 150. Having a structure and configuration similar to those of back panel 140. Front panel 150 may be used as a door with any of the containers described here in accordance with the principles of the invention. Door 150 may be comprised of several beams 152 that may form a frame for the door, or front panel, 150. Beams 152 may give structural strength and support to the door 150. Planks 154 may be comprised of one or more broad planks of plywood or other similar material.

FIG. 16 shows an alternative embodiment of a container 160 in accordance with the principles of the invention. Container 160 may be comprised of a top panel 210, a bottom panel 200, a back panel 140 and 2 side panels 190. The container 160 may be preferable for use when hanging clothes must be moved or stored, or when relatively large objects are desired to be placed within the container 160.

FIG. 17 shows an exemplary exterior 170 of a side panel. The exterior 170 may include a plurality of beams 172 that may provide a frame giving rigidity and structural support to a side panel and function similarly to beams 142 and beams 152 of FIGS. 14 and 15, respectively. Planks 174 may be comprised of one or more planks. Exterior 170 may be equally suitable for side panels 180 and 190.

FIG. 18 shows the interior of a side panel 180, which may be suitable for use in storage containers such as the one shown in FIG. 13. The interior of a side panel 180 may include a planar plank 186 having a plurality of slots 182, which may removably engage one or more shelves inserted into a container. Slots 182 may be comprised of simple grooves and may optionally include means for holding shelves in place. Optionally, the grooves 182 themselves may be slidably adjustable to alternative positions on the side panel 180.

FIG. 19 shows the interior of a side panel 190 which may be suitable for use in storage containers such as the one shown in FIG. 16. The interior of a side panel 190 may include a planar plank 196. Plank 196 may have a plurality of slots 194 for removable engagement of one or more shelves. The interior of a side panel 190 may further include a socket 192 for supporting a hanging rod from which clothes may be hung. FIGS. 18 and 19 show alternative configurations for the interior of a side panel of a container in accordance with the principles of the invention. Other configurations may optionally be used which may provide more or fewer shelves, more or fewer hanging rods or other mechanisms. For example, it may be desirable to include one or more hooks, which may be used to engage bungee cord, twine, other webbing, bags, sacks or other items that may be used during a move.

FIG. 20 shows a bottom panel 200 for use with any of the containers in accordance with the principles of the invention. Bottom panel 200 may have a structure similar to other panels or components of containers. A plurality of beams 202 may form a frame providing rigidity and structural support. Plank 204 may be comprised of one or more planar flanks comprised of a material such as plywood, particleboard or the like. It may be preferable for a bottom panel to be stronger, more rigid and/or more structurally sound than other components of a container such that it may support heavy items placed on it and so that it may resist bending or warping such that a plurality of wheels attached to the bottom panel 200 may remain aligned along a common plane.

FIG. 21 shows a top panel 210 for use with any of the containers in accordance with the principles of the invention. As with other components described herein, a top panel 210 may include a plurality of beams 212 forming a rigid frame and plank 214 that may be comprised of one or more planks. Optionally, a top panel 210 may have a frame and/or overall rigidity less than that of other components of the invention.

Optionally, both the interior and the exterior of a container in accordance with the principles of the invention may include padding. It is known to use blankets, pads, other packaging material and the like when transporting objects during a move in order to prevent damage. Such objects may also be used to firmly hold the packed items in place. It may therefore be desirable to line the inside of the container as well as shelves inside the container with felt or other padding. It may also be desirable to coax all or portions of the exterior of the container with rubber or other padding. By padding the outside of the container, or at least the corners and edges of the container and door, damage to hallways doorways and the like may be prevented.

Other optional features include a stopper or break located on one or more of the wheels such that the container may be part and will not roll. Optionally, each container may include a computer chip that allows the real-time tracking of the location of a container. This may assist with logistics, prevent theft and further organize a move by recording which boxes contain which items.

The containers may be used to simplify the methodology by which a home, office or other environment may be packed up and moved to a 2nd location. Initially, a plurality of containers may be provided at the first location. Each of the containers may be individually loaded. Optionally, persons moving may pack boxes, which may be placed in the containers. However, the containers may be directly packed, thereby simplifying and speeding the packing process. Because the containers may contain lining and because additional packing material may be added to the container, items placed or packed in them may not be damaged. Hanging clothes may be placed upon a rod within the container such that they remain hanging, as shown in FIG. 6.

Once a container is adequately filled, the door may be placed on the container and secured by means of clamps or other devices. When all of the containers have been packed, they may be placed in a vehicle such as a moving truck. Because the containers have wheels on their bottoms, they may simply be rolled out of the first location, up a ramp and into the loading truck. Each container may be handled by as few as one person. When the containers are loaded in the truck, they may be lined up side-by-side, and in several roads. Because they are all of the same dimensions, they are easily packed together in a secure manner.

When the destination is reached, the containers may simply be rolled out of the truck, down a ramp and into the new location. They may then be unpacked. When the process is complete, the containers may be reused several times over. During the transportation process, little damage may be caused by the containers where they are padded or include other material such as rubber on their exterior. If a corner or doorjamb is bumped, no damage will be caused. In addition, the containers may be left on their own for short periods of time while others are managed. For example, one or more containers may be placed near an elevator for a relatively short period of time with a greatly reduced concern that anyone will remove or steal an object from them. Because the doors are secured by clamps which are relatively difficult to remove, investigating a container requires several minutes. Any opportunistic thieves would be discouraged from tampering with something sealed that tightly.

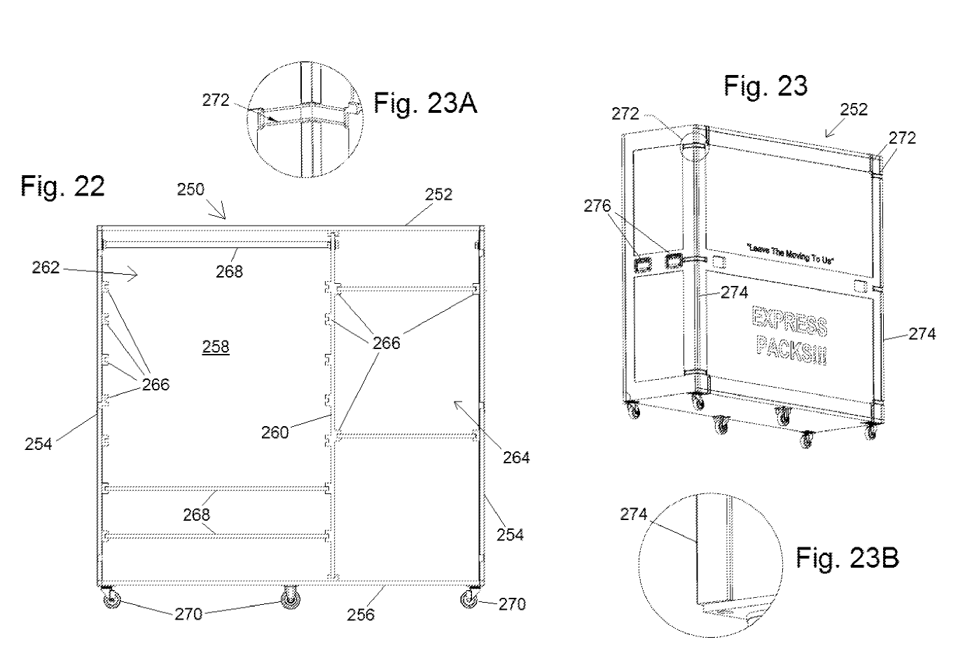

FIG. 22 shows an alternative embodiment of a moving container 250 and shown from the front with the door removed so that the interior of the container 250 may be seen. As with other embodiments, moving container 250 has a top panel 252, two side panels 254 a bottom panel 256 and a back panel 258. Moving container 250 also includes an interior panel 260 that may divide the interior of the container into two separate compartments to 62 and 264. The inside walls of side panels 254 and the interior panel 260 may each have a plurality of slots to 66 that may allow shelves to 68 to be inserted inside the container. In this embodiments, a removable Rod 268 traverses the with of interior compartment 262 for hanging close. Wheels 270 extending downward from bottom panel 258.

FIG. 23 shows a perspective view of container 252. In FIG. 20 3K shows in greater detail, clamps, 272 that may be used to hold the door and/or other panels of the moving container securely. Clamp 272 may not require the use of tools to remove. FIG. 23. Being shows an enlarged view of padding 274. Padding 274 may be located along the corners or other edges of the container 252. This may prevent the containers from being damaged or from the containers damaging other objects during transportation. Containers 252 may also include one or more handles 276 that may be used to manipulate and position the containers 252. Handles 276 may fold down and lie flush with the sides of the container such as that they are out of the way.

Whereas, the present invention has been described in relation to the drawings attached hereto, it should be understood that other and further modifications, apart from those shown or suggested herein, may be made within the spirit and scope of this invention. Descriptions of the embodiments shown in the drawings should not be construed as limiting or defining the ordinary and plain meanings of the terms of the claims unless such is explicitly indicated.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

1. A parallelepiped transportation container comprising a top panel, a bottom panel having wheels extending downward, two side panels, a back panel, a front opening and a door, wherein the door may be removably secured to the front of the container.

2. The transportation container of claim 1 further comprising a plurality of vertically arranged slots inside of the container and a plurality of shelves removably engaged with the slots.

3. The transportation container of claim 1 further comprising a removable rod for hanging clothes.

4. The transportation container of claim 1 wherein the door is secured to the front of the container by a lower lip extending from the top panel and a bottom lip extending from the bottom panel.

5. The transportation container of claim 4 wherein the door is further secured to the container by means of clamps that are removably attachable by hand without use of tools.

6. The transportation container of claim 1 wherein the door is secured to the container by means of clamps that are removably attachable by hand without use of tools.

7. The transportation container of claim 1 wherein the side panels, the back panel and the door are are each comprised of beams and boards.

8. The transportation container of claim 1 further comprising padding on the outside of the container.

9. The transportation container of claim 1 further comprising wheels extending downward from the bottom panel

10. The transportation container of claim 9 further comprising brakes that lock the wheels in place.

11. The transportation container of claim 10 further comprising a plurality of vertically arranged slots inside of the container and a plurality of shelves removably engaged with the slots.

12. The transportation container of claim 11 further comprising a removable rod for hanging clothes.

13. The transportation container of claim 12 wherein the door is secured to the front of the container by a lower lip extending from the top panel and a bottom lip extending from the bottom panel.

14. The transportation container of claim 13 wherein the door is further secured to the container by means of clamps that are removably attachable by hand without use of tools.

15. The transportation container of claim 14 further comprising handles on the side panels that fold down to lie flush with the side panels when not in use.

16. A method for moving objects comprising:
packing the objects into one or more containers each having a top panel, a bottom panel, two sides panels, a back panel, a front and a removable door and wheels extending downward from the bottom panel;
placing the container into a vehicle;
packing multiple containers adjacent to and flush with one another;
transporting the vehicle to a desired location;
unloading the containers by rolling them down a ramp; and,
unpacking the containers at the new location.

17. The method of claim 16 wherein the containers each have a plurality of vertically arranged slots inside the container and a plurality of shelves removably engaged with the slots.

18. The method of claim 17 wherein the containers further comprise removable rods for hanging clothes.

19. The method of claim 18 wherein the door is secured to the front of the container by a lower lip extending from the top panel and a bottom lip extending from the bottom panel.

20. The method of claim 19 wherein the door is further secured to the container by means of clamps that are removably attachable by hand without use of tools.
